(19) United States
(12) Patent Application Publication
(10) Pub. No.: US 2018/0111271 A1
(43) Pub. Date: Apr. 26, 2018

(54) MECHANICAL ARM POSITIONING METHOD AND SYSTEM ADOPTING THE SAME

(71) Applicant: PEGATRON CORPORATION, TAIPEI CITY (TW)

(72) Inventors: Hsiang-Tin HWANG, TAIPEI (TW); Jen-Hui WANG, TAIPEI (TW); Chiung-Hung WANG, TAIPEI (TW); Jen-Wei CHENG, TAIPEI (TW)

(21) Appl. No.: 15/644,834

(22) Filed: Jul. 10, 2017

(30) Foreign Application Priority Data
Oct. 21, 2016 (TW) 105134128

(51) Int. Cl. B25J 9/16; H04N 5/225; G06K 9/62; G06T 7/60

(52) U.S. Cl. CPC B25J 9/1692; H04N 5/2257; G06K 9/6202; G06K 19/06037; B25J 9/1697; G05B 2219/39046; G06T 7/60

(57) ABSTRACT

A mechanical arm positioning method configured to position a mechanical arm at a fixed point. The method includes capturing a positioning pattern through an image-capturing module disposed on mechanical arm to generate an image with a positioning image, the positioning image corresponding to positioning pattern. Subsequently, whether a center of positioning image is located at a center of the image is determined. If not, a position of mechanical arm is adjusted in parallel with a plane where the positioning pattern is located until the center of positioning image is located at the center of the image. Subsequently, whether an area of positioning image is substantially equal to a predetermined area is determined. If not, a distance between mechanical arm and positioning pattern is adjusted perpendicular to plane where the positioning pattern is located until the area of positioning image is substantially equal to predetermined area.

### RELATED APPLICATIONS

This application claims priority to Taiwan Application Serial Number 105134128, filed Oct. 21, 2016, which is herein incorporated by reference.

### BACKGROUND

### Technology Field

The present invention relates to a mechanical arm positioning method. More particularly, the present invention relates to a mechanical arm positioning method applied to three degrees of freedom or six degrees of freedom.

### Description of Related Art

With the progress of science and technology, mechanical arms that never get tired and work continuously have been gradually introduced into production lines requiring a large amount of repetitive actuation to replace the traditional manpower on the production line. However, due to the spatial errors probably accumulated during the continuous actuating processes of the mechanical arms, the mechanical arms gradually deviate from predetermined strokes in which the mechanical arms are preset to move and actuate between various fixed points. Therefore, after the mechanical arms have operated for a period of time, the operators need to re-adjust the positioning of the mechanical arms. However, not only does the adjustment consume manpower, but it also takes a longer working time to ensure the positioning accuracy of the mechanical arms during the fine-tuning process. The waste of time and manpower is thus caused. Even more, the adjustment work carried out by manpower is still easy such that omissions or generate errors, which in turn affect subsequent actuations of the mechanical arms. In addition, it can not cope with the adjustment work of the mechanical arms on heavier, faster production lines.

For the foregoing reasons, there is a need to solve the above-mentioned problems by providing a mechanical arm positioning method and a system adopting the same, which is also an objective that the industry is eager to achieve.

### SUMMARY

One aspect or the present invention is related to a mechanical arm positioning method that uses the image-capturing module to capture the positioning pattern so as to generate the comparison image with an image of the positioning pattern. In addition, distance relationships between the mechanical arm and the fixed point along various axes in the space are determined through comparing the relative position and relative area between the image of the positioning pattern and the comparison image so as to adjust the mechanical arm to the fixed point. As a result, the mechanical arm can be more accurately positioned at the fixed point, and the amount of computation and computation time required for adjusting the mechanical arm are reduced to reduce the burden of the computing device and the length of the computation time.

A mechanical arm positioning method configured to position a mechanical arm at a fixed point is provided. The mechanical arm positioning method comprises: capturing a positioning pattern through utilizing a image-capturing module disposed on the mechanical arm to obtain a comparison image with a positioning image, the positioning image corresponding to the positioning pattern; determining whether a center of the positioning image is located at a center of the comparison image; adjusting a position of the mechanical arm in parallel with a plane where the positioning pattern is located such that the center of the positioning image to be located at the center of the comparison image if the center of the positioning image is not located at the center of the comparison image; determining whether an area of the positioning image is substantially equal to a predetermined area; and adjusting a position of the mechanical arm perpendicular to the plane where the positioning pattern is located to change a distance between the image-capturing module and the positioning pattern if the area of the positioning image is not equal to the predetermined area such that the area of the positioning image to be substantially equal to the predetermined area.

In the foregoing, the mechanical arm positioning method further comprises: determining whether an acute angle between an edge of the positioning image and an edge of the comparison image is substantially equal to a predetermined angle; and rotating the mechanical arm in parallel with the plane where the positioning pattern is located if the acute angle is not equal to the predetermined angle such that the acute angle to be equal to the predetermined angle. The predetermined angle is generated by using the image-capturing module to capture the positioning pattern when the mechanical arm is located at the fixed point.

In the foregoing, the step of determining whether the area of the positioning image is substantially equal to a predetermined area comprises: determining a magnitude relationship between the area of the positioning image and the predetermined area; adjusting the mechanical arm such that the mechanical arm to move away from the positioning pattern along a direction perpendicular to the plane where the positioning pattern is located if the area of the positioning image is larger than the predetermined area; and adjusting the mechanical arm such that the mechanical arm to move closer to the positioning pattern along the direction perpendicular to the plane where the positioning pattern is located if the area of the positioning image is smaller than the predetermined area.

In the foregoing, the mechanical arm positioning method further comprises: utilizing the image-capturing module to capture the positioning pattern so as to generate a standard image with a standard positioning image when the mechanical arm is located at the fixed point; and generating the predetermined area based on an area of the standard positioning image.

In the foregoing, the mechanical arm further comprises a three-axis gravitational acceleration measurement module having a three-axis gravitational acceleration value disposed on the mechanical arm. The three-axis gravitational acceleration value corresponds to degrees of rotation of the mechanical arm. The mechanical arm positioning method further comprises: determining whether the three-axis gravitational acceleration value is substantially equal to a predetermined three-axis gravitational acceleration values; and rotating the mechanical arm such that the three-axis gravitational acceleration value of the three-axis gravitational acceleration measurement module to be substantially equal to the predetermined three-axis gravitational acceleration value if the three-axis gravitational acceleration value is not equal to the predetermined three-axis gravitational acceleration value.

In the foregoing, the mechanical arm positioning method further comprises: capturing the three-axis gravitational acceleration value of the three-axis gravitational acceleration measurement module to generate standard gravity sensing data when the mechanical arm is located at the fixed point; and generating the predetermined three-axis gravitational acceleration value based on values of the standard gravity sensing data.

Another aspect of the present invention is related to a mechanical arm system that utilizes the image-capturing module disposed at the movable end of the mechanical arm to capture the positioning pattern so as to generate the comparison image with the image of the positioning pattern. In addition, distance relationships between movable end and the fixed point along various axes in the space are determined through comparing the relative position and relative area between the image of the positioning pattern and the comparison image so as to drive the driving member to adjust the movable end to the fixed point. As a result, the movable end of the mechanical arm can be more accurately positioned at the fixed point, and the amount of computation and computation time required for adjusting the mechanical arm are reduced to reduce the burden of the computing device and the length of the computation time. At the same time, the time required for repositioning is reduced.

The invention provides a mechanical arm system. The mechanical arm system comprises a mechanical arm, an image-capturing module, and a computing device. The mechanical arm comprises a movable end and at least one driving member. The driving member is configured to move the movable end to a fixed point. The image-capturing module is fixed to the movable end. The image-capturing module is configured to capture a positioning pattern at a moving point so as to generate a comparison image with a positioning image. The positioning image corresponds to the positioning pattern. The computing device is configured to determine whether a center of the positioning image is located at a center of the comparison image. If not, the driving member is driven to adjust a position of the movable end in parallel with a plane where the positioning pattern is located such that the center of the positioning image to be located at the center of the comparison image. The computing device is further configured to determine whether an area of the positioning image is substantially equal to a predetermined area. If not, the driving member is driven to adjust a position of the movable end along a direction perpendicular to the plane where the positioning pattern is located to change a distance between the image-capturing module and the positioning pattern so as such that the area of the positioning image to be substantially equal to the predetermined area.

In the foregoing, the computing device is further configured to determine a magnitude relationship between the area of the positioning image and the predetermined area. The driving member is driven such that the movable end to move away from the positioning pattern along the direction perpendicular to the plane where the positioning pattern is located if the area of the positioning image is larger than the predetermined area. The driving member is driven to adjust the mechanical arm such that the movable end to move closer to the positioning pattern along the direction perpendicular to the plane where the positioning pattern is located if the area of the positioning is smaller than the predetermined area.

In the foregoing, the image-capturing module is further configured to utilize the image-capturing module to capture the positioning pattern so as to generate a standard image with a standard positioning image when the movable end of the mechanical arm is located at the fixed point, and generate the predetermined area based on the standard positioning image.

In the foregoing, the driving member is further configured to rotate the movable end. The computing device is further configured to determine whether an acute angle between an edge of the positioning image and an edge of the comparison image is substantially equal to a predetermined angle. If not, the driving member is driven to rotate the movable end in parallel with the plane where the positioning pattern is located such that the acute angle between the edge of positioning image and the edge of the comparison image to be substantially equal to the predetermined angle.

In the foregoing, the driving member is further configured to rotate the movable end. The mechanical arm system further comprises a three-axis gravitational acceleration measurement module disposed on the mechanical arm. The three-axis gravitational acceleration measurement module is configured to measure a three-axis gravitational acceleration value corresponding to degrees of rotation of the movable end of the mechanical arm. The computing device is further configured to determine whether the three-axis gravitational acceleration value is substantially equal to a predetermined three-axis gravitational acceleration value. If not, the driving member is driven to rotate the movable end so as such that the three-axis gravitational acceleration value of the three-axis gravitational acceleration measurement module to be substantially equal to the predetermined three-axis gravitational acceleration value.

In the foregoing, the three-axis gravitational acceleration measurement module is further configured to capture the three-axis gravitational acceleration value of the three-axis gravitational acceleration measurement module to generate standard gravity sensing data when the movable end of the mechanical arm is located at the fixed point, and generate the predetermined three-axis gravitational acceleration value based on the standard gravity sensing data.

It is to be understood that both the foregoing general description and the following detailed description are by examples, and are intended to provide further explanation of the invention as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts a three-dimensional view of a mechanical arm system according to one embodiment of this invention;

FIG. 2 depicts a three-dimensional view of an image-capturing module disposed in a mechanical arm system according to one embodiment of this invention;

FIG. 3 depicts an actuation flowchart of a mechanical arm positioning method according to one embodiment of this invention;

FIG. 4 depicts a schematic diagram of a standard image according to one embodiment of this invention;

FIG. 5A, FIG. 5B, FIG. 6A, and FIG. 6B depict schematic diagrams of comparison images according to various embodiments of this invention;

FIG. 7 depicts an actuation flowchart of a mechanical arm positioning method according to another embodiment of this invention; and

FIG. 8 depicts a schematic diagram of a comparison image according to one embodiment of this invention; unless otherwise specified, the same number and sign in different drawings generally refer to the corresponding parts. The drawings are illustrated to clearly express the relevant associations of the embodiments rather than depict the actual dimensions.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and components are schematically depicted in order to simplify the drawings.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

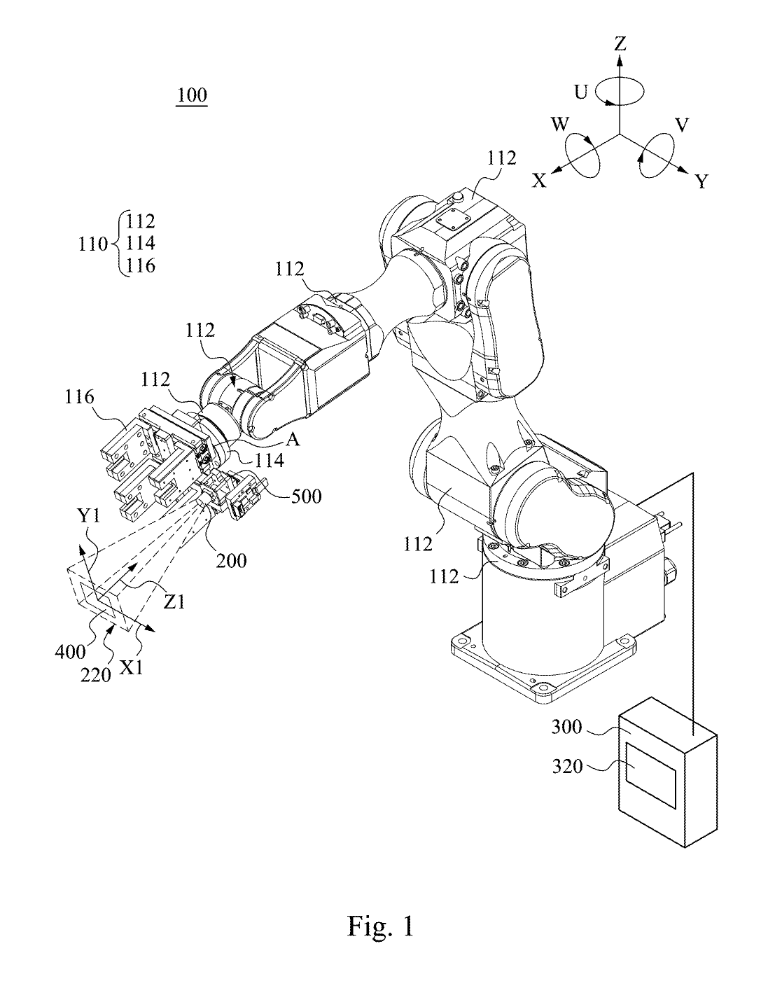

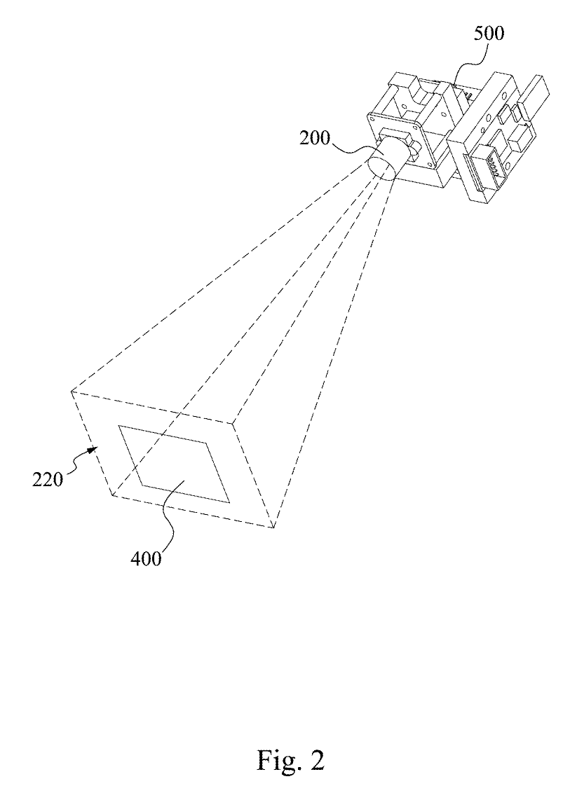

FIG. 1 depicts a three-dimensional view of a mechanical arm system 100 according to one embodiment of this invention. FIG. 2 depicts a three-dimensional view of an image-capturing module 200 disposed in the mechanical arm system 100 according to one embodiment of this invention. As shown in FIG. 1, the mechanical arm system 100 comprises a mechanical arm 110, the image-capturing module 200, and a computing device 300. The mechanical arm 110 comprises at least one driving member 112, a movable end 114, and a gripping unit 116. In one embodiment, the driving member 112 may be configured to move the movable end 114 to a fixed point A so as such that the gripping unit 116 to actuate at a correct position and angle. In other embodiments, the driving member 112 may further be configured to rotate the movable end 114. In greater detail, in one embodiment, the driving member 112 can move the movable end 114 respectively along the X axis, Y axis, and Z axis so that the movable end 114 can freely move between the fixed point A and other positions. In other embodiments, the driving member 112 can rotate the movable end 114 respectively along the W axis, U axis, and V axis. The W axis corresponds to a rotation angle of the movable end 114 with respect to the X axis, the V axis corresponds to a rotation angle of the movable end 114 with respect to the Y axis, and the U axis corresponds to a rotation angle of the movable end 114 with respect to the Z axis.

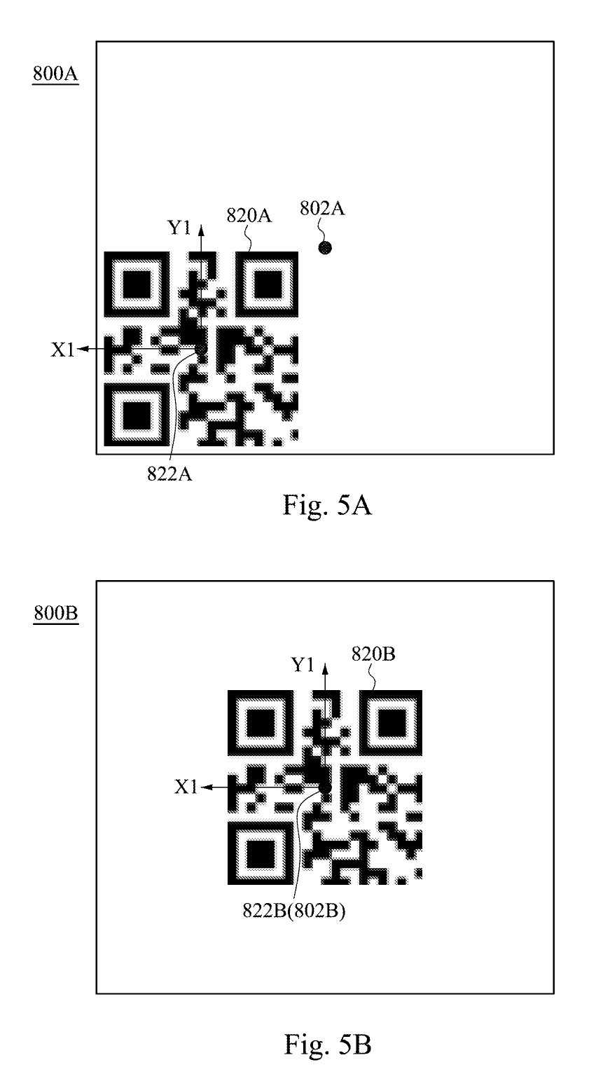

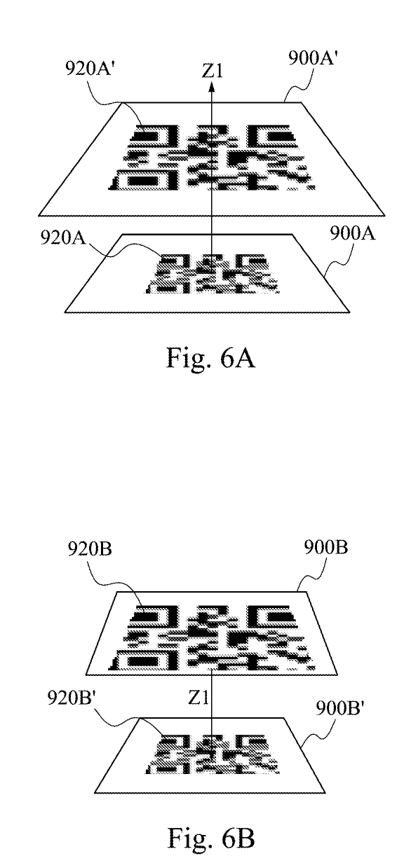

A description is provided with reference to FIG. 1 and FIG. 2. The image-capturing module 200 is fixed to the movable end 114, and can freely move in a space with the movable end 114. In other embodiments, the image-capturing module 200 may be further fixed to a position beside the gripping unit 116. The image-capturing module 200 may be configured to capture a positioning pattern 400 in a field of view 220 at different moving points, such as the fixed point A, moving points P1, P2, P3, etc., and generate a comparison image with a positioning image, for example, comparison images 800A-900B and positioning images 820A-920B depicted in FIG. 5A to FIG. 6B. However, the present invention is not limited in this regard, and a detailed description is provided as follows. The positioning image corresponds to the positioning pattern 400. In one embodiment, the positioning pattern 400 may be a two-dimensional QR code or some other suitable two-dimensional patterns.

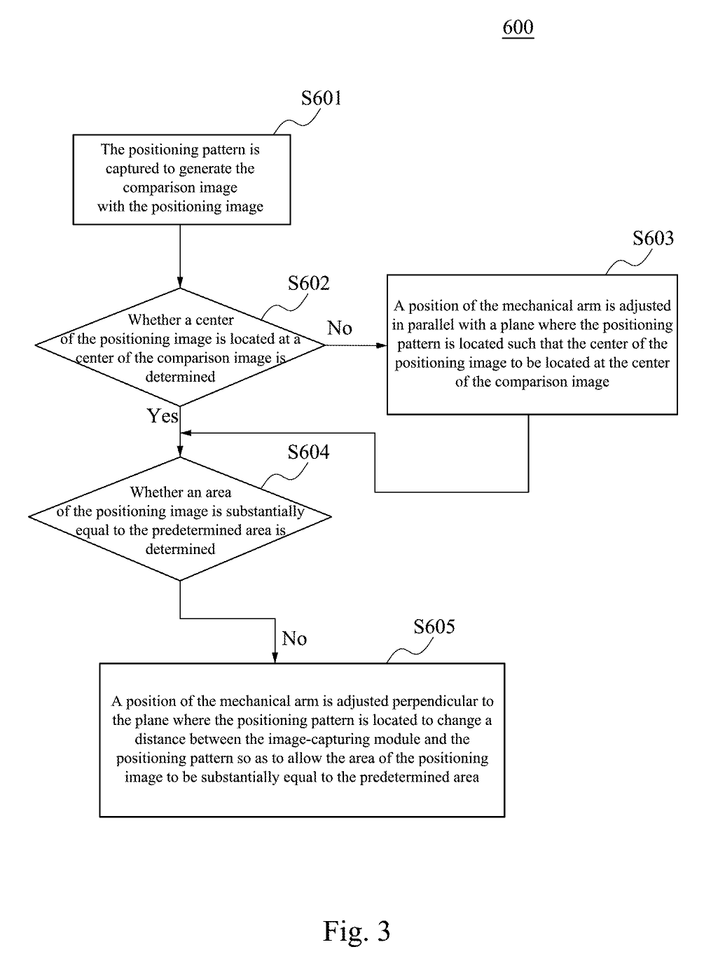

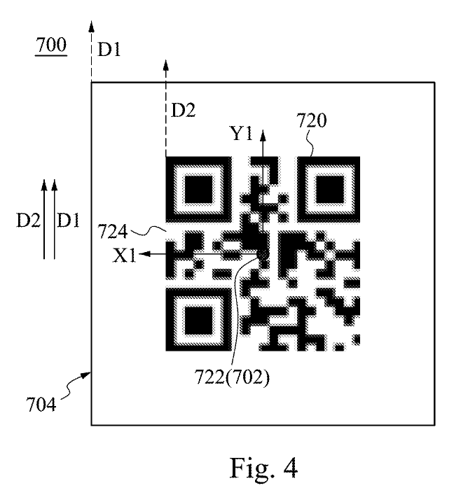

FIG. 3 depicts an actuation flowchart of a mechanical arm positioning method 600 according to one embodiment of this invention. FIG. 4 depicts a schematic diagram of a standard image 700 according to one embodiment of this invention. FIG. 5A to FIG. 6B depict schematic diagrams of the comparison images 800A-900B according to various embodiments of this invention. A description is provided with reference to FIG. 1 and FIG. 4. In one embodiment, when the movable end 114 of the mechanical arm 110 is located at the fixed point A, the positioning pattern 400 in the field of view 220 can be captured through the image-capturing module 200 to generate a standard image 700 with a standard positioning image 720. The standard positioning image 720 is an image generated correspondingly by using the image-capturing module 200 to take a picture of or capture the positioning pattern 400. The standard image 700 may have a plurality of pixels (not shown in the figure) and an image center 702. The standard positioning image 720 may have a center point 722. The center point 722 substantially overlaps the image center 702 of the standard image 700. In one embodiment, the computing device 300 can calculate a numerical value of a predetermined area A₀ in a pixel space based on a number of pixels occupied by the standard positioning image 720, but the present invention is not limited in this regard. For example, in other embodiments, the computing device 300 can further correspond the pixels of the standard image 700 to a real area in a space to use the real area in the space to calculate the value of the predetermined area A₀ of the standard positioning image 720. In other embodiments, the computing device 300 can calculate the value of the predetermined area A₀ of the standard positioning image 720 based on a percentage of an area of the standard image 700 occupied by the standard positioning image 720. The computing device 300 may have a storage module 320 configured to record the value of the predetermined area A₀, but the present invention is not limited in this regard. The computing device 300 may, for example, generate a positioning frame in the standard image 700 based on an outer edge of the standard positioning image 720, and record the positioning frame in the storage module 320.

A description is provided with reference to FIG. 3 and FIG. 5A. The mechanical arm positioning method 600 can begin at step S601. In step S601, the image-capturing module 200 is used to capture the positioning pattern 400 in the field of view 220 to generate the comparison image 800A with the positioning image 820A. The comparison image 800A has an image center 802A, and the positioning image 820A has a center point 822A. The positioning image 820A can correspond to the positioning pattern 400. That is, the scaled-down positioning image 820A can be substantially the same as the positioning pattern 400.

A description is provided with reference to FIG. 1, FIG. 3, and FIG. 5A. Then, the mechanical arm positioning method 600 proceeds to step S602. In step S602, whether the center point 822A of the positioning image 820A is located at the image center 802A of the comparison image 800A is determined. If not, that is, the center point 822A of the positioning image 820A is not located at the image center 802A of the comparison image 800A, the mechanical arm positioning method 600 can further proceed to step S603. The driving member 112 is driven to actuate the mechanical arm 110 so as to adjust a position of the movable end 114 along a direction X1 and a direction Y1 in parallel with a plane where the positioning pattern 400 is located. The center point 822A of the positioning image 820A is thus allowed to be moved to the image center 802A of the comparison image 800A. In greater detail, when a relationship between the positioning image and the comparison image achieves the situation in which a center point 822B of the positioning image 820B overlaps an image center 802B of the comparison image 800B as shown in FIG. 5B, an adjustment of the movable end 114 can be stopped and the mechanical arm positioning method 600 proceeds to step S604. If yes, for example, if the positioning pattern 400 captured by the image-capturing module 200 is like the comparison image 800B of FIG. 5B, step S604 can be directly performed after performing step S602. Steps S602 and S603 may be implemented by using software or firmware written in an integrated circuit or the computing device 300.

A description is provided with reference to FIG. 3 and FIG. 6A. The mechanical arm positioning method 600 proceeds to step S604. In step S604, whether an area A₁ of the positioning image 920A of the comparison image 900A is substantially equal to the predetermined area A₀ is determined. If not, that is, the area A₁ of the positioning image 920A is not equal to the predetermined area A₀, the mechanical arm positioning method 600 can proceed to step S605. The driving member 112 is driven to actuate the mechanical arm 110 so as to adjust a position of the movable end 114 along a direction Z1 perpendicular to the plane where the positioning pattern 400 is located. A distance between the image-capturing module 200 and the positioning pattern 400 is thus changed such that an area A₂ of an adjusted positioning image 920A′ to be substantially equal to the predetermined area A₀. Steps S604 and S605 may be implemented by using software or firmware written in an integrated circuit or the computing device 300.

A description is provided with reference to FIG. 3 and FIG. 6B. In one embodiment, magnitude relationships between the area A₁ of the positioning image 920A, an area A₃ of the positioning image 920B, and the predetermined area A₀ may be further determined in step S604. For example, if the area A₃ of the positioning image 920B is larger than the predetermined area A₀, then in step S605, the driving member 112 is driven to actuate the mechanical arm 110 so as such that the movable end 114 to move away from the positioning pattern 400 along the direction Z1 perpendicular to the plane where the positioning pattern 400 is located until an area A₄ of an adjusted positioning image 920B′ is substantially equal to the predetermined area A₀. For another example, if the area A₁ of the positioning image 920A is smaller than the predetermined area A₀, then in step S605, the driving member 112 is driven to actuate the mechanical arm 110 so as such that the movable end 114 to move closer to the positioning pattern 400 along the direction Z1 perpendicular to the plane where the positioning pattern 400 is located until the area A₂ of the adjusted positioning image 920A′ is substantially equal to the predetermined area A₀.

Since the mechanical arm positioning method 600 first adjusts the movable end 114 to position the center point of the positioning image at the image center of the comparison image, for example, the center point 822B of the positioning image 820B is overlapped with the image center 802B of the comparison image 800B so that the movable end 114 is collinear with the fixed point A along the direction Z1 perpendicular to the plane of the positioning pattern 400. After that, the movable end 114 is adjusted along the direction Z1 such that the area of the positioning image to be substantially equal to the predetermined area, for example, such that the area A₂ of the positioning image 920A′ to be substantially equal to the predetermined area A₀. As a result, the movable end 114 can be adjusted to the fixed point A from the other moving points P1, P2, P3 in the space with the assistance of the image-capturing module 200. Even more, the computing device 300 can further perform the mechanical arm positioning method 600 automatically to achieve full automation of the positioning of the mechanical arm system 100 through judging the comparison image captured by the image-capturing module 200 to actuate the mechanical arm 110 correspondingly.

In addition, distortion at an edge of the comparison image can be avoided by positioning the positioning pattern 400 at a center of the field of view 220 such that the area of the positioning image to be better corresponded to the positioning pattern 400 in the field of view 220. The positioning accuracy of the movable end 114 is thus increased. In other embodiments, the comparison image captured by the image-capturing module 200 may be pre-processed, such as processed by a flat field correcting, etc., such that the area of the positioning image to be better corresponded to the positioning pattern 400 in the field of view 220.

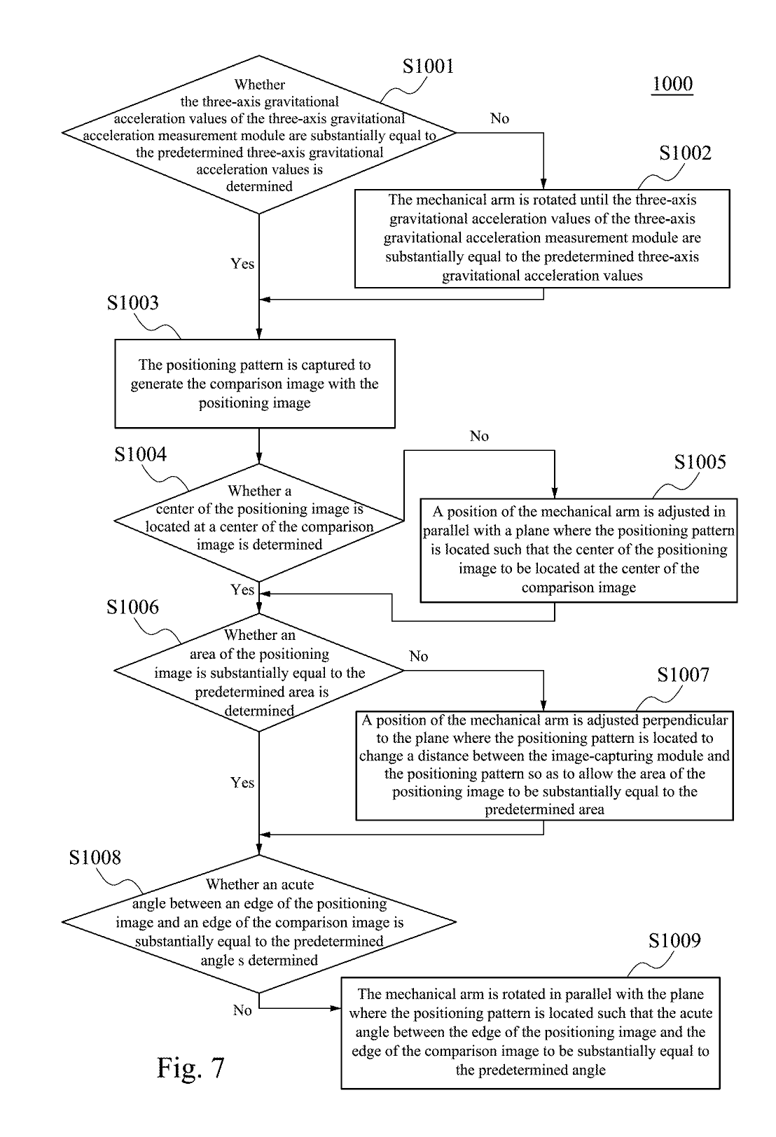

FIG. 7 depicts an actuation flowchart of a mechanical arm positioning method 1000 according to another embodiment of this invention. A description is provided with reference to FIG. 1, FIG. 2, and FIG. 7. The driving member 112 can further rotate the movable end 114 along the W axis, the V axis, and the U axis. The mechanical arm system 100 may further comprise a three-axis gravitational acceleration measurement module 500. The three-axis gravitational acceleration measurement module 500 is disposed at the movable end 114 of the mechanical arm 110. In some embodiments, the three-axis gravitational acceleration measurement module 500 and the image-capturing module 200 may be co-disposed on the gripping unit 116. The three-axis gravitational acceleration measurement module 500 can be configured to measure three-axis gravitational acceleration values to correspond to degrees of rotation of the movable end 114 of the mechanical arm 110. In greater detail, the three-axis gravitational acceleration values respectively correspond to components of gravitational acceleration on the X-axis, Y-axis, and Z-axis. Rotation angles of the movable end 114 on the W axis and the V axis can be determined based on magnitudes of the components on the various axes.

In one embodiment, when the movable end 114 of the mechanical arm 114 is located at the fixed point A, standard gravity sensing data can be generated through capturing gravitational acceleration values of the three-axis gravitational acceleration measurement module 500 on the W-axis, the V-axis, and the U-axis. The computing device 300 can generate predetermined three-axis gravitational acceleration values g_{W0}, g_{V0} based on the standard gravity sensing data, and store the predetermined three-axis gravitational acceleration values g_{W0}, g_{V0} in the storage module 320. In other embodiments, the predetermined three-axis gravitational acceleration values g_{W0}, g_{V0} may have initial values stored in the storage module 320.

A description is provided with reference to FIG. 1 and FIG. 7. A mechanical arm positioning method 1000 can begin at step S1001. In step S1001, three-axis gravitational acceleration values g_{W1}, g_{V1} of the three-axis gravitational acceleration measurement module 500 are captured, and whether the three-axis gravitational acceleration values g_{W1}, g_{V1} are substantially equal to the predetermined three-axis gravitational acceleration values g_{W0}, g_{V0} is determined. If not, that is, the three-axis gravitational acceleration values g_{W1}, g_{V1} are not equal to the predetermined three-axis gravitational acceleration values g_{W0}, g_{V0}, step S1002 can be further performed. The driving member 112 is driven to rotate the movable end 114 until adjusted three-axis gravitational acceleration values g_{W1′}, g_{V1′} of the three-axis gravitational acceleration measurement module 500 are substantially equal to the predetermined three-axis gravitational acceleration values g_{W0}, g_{V0}, so that the mechanical arm positioning method 1000 proceeds to step S1003. Steps S1001 and S1002 may be implemented by using software or firmware written in an integrated circuit or the computing device 300.

As shown in FIG. 7, the mechanical arm positioning method 1000 proceeds to step S1003-S1007 such that a center of the positioning pattern 400 to overlap the center of the field of view 220. At the same time, an area A₅ of a positioning image generated based on the positioning pattern 400 may be made substantially equal to the predetermined area A₀. Steps S1003-S1007 of the mechanical arm positioning method 1000 may correspond to steps S601-S605 of the mechanical arm positioning method 600.

A description is provided with reference to FIG. 4. In one embodiment, the standard image 700 may further have an image edge 704 extending along a direction D1. The standard positioning image 720 may further have an edge 724 extending along a direction D2. The computing device 300 can generate a value of a predetermined angle θ₀ based on an angle between the direction D1 and the direction D2, and record the value of the predetermined angle θ₀ in the storage module 320. In other embodiments, the value of the predetermined angle θ₀ may have an initial value stored in the storage module 320. In the present embodiment, the value of the predetermined angle θ₀ may be 0 or 180, but the present invention is not limited in this regard. In other embodiments, the value of the predetermined angle θ₀ may be 30, 45, 75, etc., but the present invention is not limited in this regard.

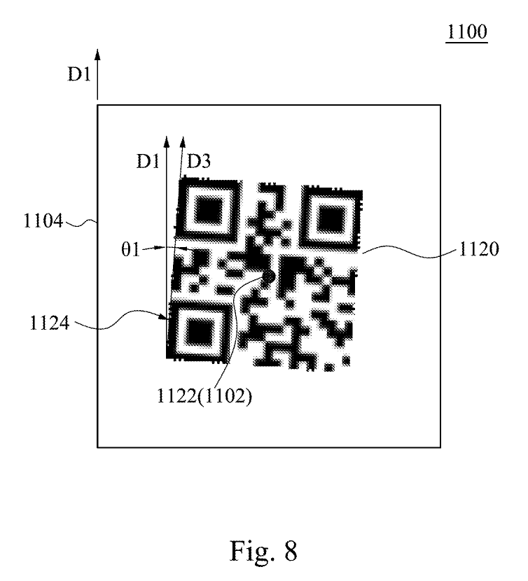

A description is provided with reference to FIG. 7 and FIG. 8. In one embodiment, the mechanical arm positioning method 1000 proceeds to step S1008. In step S1008, whether an acute angle θ₁ between an edge 1124 of a positioning image 1120 and an edge 1104 of a comparison image 1100 is substantially equal to the predetermined angle θ₀ is determined. If not, that is, a value of the acute angle θ₁ is different from the value of the predetermined angle θ₀, the mechanical arm positioning method 1000 proceeds to step S1009. The driving member 112 is driven to rotate the movable end 114 in parallel with the plane where the positioning pattern 400 is located such that an acute angle θ₁′ between the edge 1124 of the positioning image 1120 and the edge 1104 of the comparison image 1100 thus adjusted to be substantially equal to the predetermined angle θ₀. Steps S1008 and S1009 may be implemented by using software or firmware written in an integrated circuit or the computing device 300.

Since the mechanical arm positioning method 1000 first adjusts the rotation angles of the movable end 114 on the W axis the V axis, the Z axis of the movable end 114 can thus be substantially in parallel with a Z1 axis of the positioning pattern 400. Then, the center point of the positioning image is positioned at the image center of the comparison image in parallel with a plane constituted by an X1 axis and a Y1 axis of the positioning pattern 400 so that the movable end 114 is collinear with the fixed point A along the direction Z1 perpendicular to a plane of the positioning pattern 400. After that, the movable end 114 is adjusted along the direction Z1 such that the area of the positioning image to be substantially equal to the predetermined area. In addition, the movable end 114 is rotated along the U axis such that the X axis and the Y axis of the movable end 114 to be in parallel with the X1 axis and the Y1 axis of the positioning pattern 400. As a result, the movable end 114 can be adjusted to the fixed point A from the other moving points P1, P2, P3 in the space by using a predetermined rotation angle with the assistance of the image-capturing module 200. Even more, the computing device 300 can further perform the mechanical arm positioning method 1000 automatically to achieve full automation of the positioning of the mechanical arm system 100 through judging the three-axis gravitational acceleration values of the three-axis gravitational acceleration measurement module 500 and the comparison image captured by the image-capturing module 200 to actuate the mechanical arm 110 with six degrees of freedom correspondingly. The use of manpower is reduced.

It is noted that the description of a value of the area A₂ being substantially equal to the value of the predetermined area A₀, the three-axis gravitational acceleration values g_{W1}′, g_{V1}′ being substantially equal to the predetermined three-axis gravitational acceleration values g_{W0}, g_{V0}, and a value of the acute angle θ₁′ being substantially equal to the value of the predetermined angle θ₀ in the present disclosure is not intended to limit the present invention. For example, the area A₂ may be an area in the pixel space, and a unit conversion is necessary to correspond the area A₂ to the predetermined area A₀ that uses the area in the real space as the value. For example, the area A₂ and the predetermined area A₀ may be regarded as substantially equal within an allowable error range, such as within an error of ±1%, but the present invention is not limited in this regard. It should be understood that those of ordinary skill in the art to which this invention pertains may flexibly make selections depending on practical needs without departing from the spirit and scope of the present invention, as long as the area, the three-axis gravitational acceleration values, and the predetermined angle can be used to accurately position the mechanical arm 110 at the fixed point A.

In summary, the present invention provides a mechanical arm positioning method that uses the image-capturing module to capture the positioning pattern so as to generate the comparison image with an image of the positioning pattern. In addition, distance relationships between the mechanical arm and the fixed point along various axes in the space are determined through comparing the relative position and relative area between the image of the positioning pattern and the comparison image so as to adjust the mechanical arm to the fixed point. As a result, the mechanical arm can be more accurately positioned at the fixed point, and the amount of computation and computation time required for adjusting the mechanical arm are reduced to reduce the burden of the computing device and the length of the computation time.

The present invention further provides a mechanical arm system that utilizes the image-capturing module disposed at the movable end of the mechanical arm to capture the positioning pattern so as to generate the comparison image with the image of the positioning pattern. In addition, distance relationships between movable end and the fixed point along various axes in the space are determined through comparing the relative position and relative area between the image of the positioning pattern and the comparison image so as to drive the driving member to adjust the movable end to the fixed point. As a result, the movable end of the mechanical arm can be more accurately positioned at the fixed point, and the amount of computation and computation time required for adjusting the mechanical arm are reduced to reduce the burden of the computing device and the length of the computation time. At the same time, the time required for repositioning is reduced.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mechanical arm positioning method configured to position a mechanical arm at a fixed point, the mechanical arm positioning method comprising:
capturing a positioning pattern through utilizing an image-capturing module disposed at the mechanical arm to obtain a comparison image with a positioning image, wherein the positioning image corresponds to the positioning pattern;
determining whether a center of the positioning image is located at a center of the comparison image;
adjusting a position of the mechanical arm in parallel with a plane where the positioning pattern is located such that the center of the positioning image to be located at the center of the comparison image if the center of the positioning image is not located at the center of the comparison image;
determining whether an area of the positioning image is substantially equal to a predetermined area; and
adjusting a position of the mechanical arm perpendicular to the plane where the positioning pattern is located to change a distance between the image-capturing module and the positioning pattern if the area of the positioning image is not equal to the predetermined area such that the area of the positioning image to be substantially equal to the predetermined area.

2. The mechanical arm positioning method of claim 1, further comprising:
determining whether an acute angle between an edge of the positioning image and an edge of the comparison image is substantially equal to a predetermined angle; and
rotating the mechanical arm in parallel with the plane where the positioning pattern is located if the acute angle is not equal to the predetermined angle such that the acute angle to be substantially equal to the predetermined angle, wherein the predetermined angle is generated by using the image-capturing module to capture the positioning pattern when the mechanical arm is located at the fixed point.

3. The mechanical arm positioning method of claim 1, wherein the determining whether the area of the positioning image is substantially equal to the predetermined area comprises:
determining a magnitude relationship between the area of the positioning image and the predetermined area;
adjusting the mechanical arm to move away from the positioning pattern along a direction perpendicular to the plane where the positioning pattern is located if the area of the positioning image is larger than the predetermined area; and
adjusting the mechanical arm to move closer to the positioning pattern along the direction perpendicular to the plane where the positioning pattern is located if the area of the positioning image is smaller than the predetermined area.

4. The mechanical arm positioning method of claim 1, further comprising:
utilizing the image-capturing module to capture the positioning pattern so as to generate a standard image with a standard positioning image when the mechanical arm is located at the fixed point; and
generating the predetermined area based on an area of the standard positioning image.

5. The mechanical arm positioning method of claim 1, wherein the mechanical arm further comprises a three-axis gravitational acceleration measurement module having a three-axis gravitational acceleration value, wherein the three-axis gravitational acceleration value corresponds to degrees of rotation of the mechanical arm, the mechanical arm positioning method further comprises:
determining whether the three-axis gravitational acceleration value is substantially equal to a predetermined three-axis gravitational acceleration value; and
rotating the mechanical arm such that the three-axis gravitational acceleration value of the three-axis gravitational acceleration measurement module to be substantially equal to the predetermined three-axis gravitational acceleration value if the three-axis gravitational acceleration value is not equal to the predetermined three-axis gravitational acceleration value.

6. The mechanical arm positioning method of claim 5, further comprising:
capturing the three-axis gravitational acceleration value of the three-axis gravitational acceleration measurement module to generate a standard gravity sensing data when the mechanical arm is located at the fixed point; and
generating the predetermined three-axis gravitational acceleration value based on values of the standard gravity sensing data.

7. A mechanical arm system comprising:
a mechanical arm comprising a movable end and at least one driving member, and the at least one driving member being configured to move the movable end to a fixed point;
an image-capturing module fixed to the movable end, the image-capturing module configured to capture a positioning pattern at a moving point so as to generate a comparison image with a positioning image, wherein the positioning image corresponds to the positioning pattern; and
a computing device configured to determine whether a center of the positioning image is located at a center of the comparison image, if not, the driving member being driven to adjust a position of the movable end in parallel with a plane where the positioning pattern is located such that the center of the positioning image to be located at the center of the comparison image, and determine whether an area of the positioning image is substantially equal to a predetermined area, if not, the driving member being driven to adjust a position of the movable end along a direction perpendicular to the plane where the positioning pattern is located to change a distance between the image-capturing module and the positioning pattern so as to allow the area of the positioning image to be substantially equal to the predetermined area.

8. The mechanical arm system of claim 7, wherein the computing device is further configured to determine a magnitude relationship between the area of the positioning image and the predetermined area, the driving member is driven such that the movable end to move away from the positioning pattern along the direction perpendicular to the plane where the positioning pattern is located if the area of the positioning image is larger than the predetermined area, the driving member is driven such that the movable end to move closer to the positioning pattern along the direction perpendicular to the plane where the positioning pattern is located if the area of the positioning image is smaller than the predetermined area.

9. The mechanical arm system of claim 7, wherein the image-capturing module is further configured to utilize the image-capturing module to capture the positioning pattern so as to generate a standard image with a standard positioning image when the movable end of the mechanical arm is located at the fixed point, and generate the predetermined area based on the standard positioning image.

10. The mechanical arm system of claim 7, wherein the driving member is further configured to rotate the movable end, wherein the computing device further determines whether an acute angle between an edge of the positioning image and an edge of the comparison image is substantially equal to a predetermined angle, if not, the driving member is driven to rotate the movable end in parallel with the plane where the positioning pattern is located such that the acute angle between the edge of positioning image and the edge of the comparison image to be substantially equal to the predetermined angle.

11. The mechanical arm system of claim 7, wherein the driving member is further configured to rotate the movable end, wherein the mechanical arm system further comprises a three-axis gravitational acceleration measurement module disposed on the mechanical arm, the three-axis gravitational acceleration measurement module is configured to measure a three-axis gravitational acceleration value corresponding to degrees of rotation of the movable end of the mechanical arm, the computing device is further configured to determine whether the three-axis gravitational acceleration value is substantially equal to a predetermined three-axis gravitational acceleration value, if not, the driving member is driven to rotate the movable end so as to allow the three-axis gravitational acceleration value of the three-axis gravitational acceleration measurement module to be substantially equal to the predetermined three-axis gravitational acceleration value.

12. The mechanical arm system of claim 11, wherein the three-axis gravitational acceleration measurement module is further configured to capture the three-axis gravitational acceleration value of the three-axis gravitational acceleration measurement module to generate a standard gravity sensing data when the movable end of the mechanical arm is located at the fixed point, and generate the predetermined three-axis gravitational acceleration value based on the standard gravity sensing data.
